(19) United States
(12) Patent Application Publication
(10) Pub. No.: US 2024/0072264 A1
(43) Pub. Date: Feb. 29, 2024

(54) HOT PRESSED, BINDER-INCLUDING MEMBRANE-ELECTRODE ASSEMBLIES

(71) Applicant: HYDROLITE LTD, Caesarea (IL)

(72) Inventors: Alina AMEL, Binyamina (IL); Aviv ASHDOT, Atlit (IL); Mordechai KATTAN, Harish (IL); Miles PAGE, Hod Hasharon (IL); Ervin TAL-GUTELMACHER, Hod Hasharon (IL)

(73) Assignee: HYDROLITE LTD, Caesarea (IL)

(21) Appl. No.: 18/502,802

(22) Filed: Nov. 6, 2023

Related U.S. Application Data
(63) Continuation-in-part of application No. 18/075,490, filed on Dec. 6, 2022.
Application No. 18/075,490 is a continuation-in-part of application No. 17/830,424, filed on Jun. 2, 2022.
Application No. 18/075,490 is a continuation-in-part of application No. PCT/IL2022/050590, filed on Jun. 2, 2022.
(60) Provisional application No. 63/211,186, filed on Jun. 16, 2021.
(60) Provisional application No. 63/221,035, filed on Jul. 13, 2021.

(30) Foreign Application Priority Data
Nov. 6, 2022 (IL) 297987

(51) Int. Cl. H01M 4/88; C25B 9/23; C25B 11/032; C25B 11/075; H01M 4/86; H01M 8/1004

(52) U.S. Cl. CPC H01M 4/8875; C25B 9/23; C25B 11/032; C25B 11/075; H01M 4/8668; H01M 4/8807; H01M 4/881; H01M 4/8825; H01M 8/1004

(57) ABSTRACT

Methods of preparing cell element(s) that are operable in alkaline or anion exchange electrochemical devices are provided, as well as corresponding cell elements and electrochemical devices such as fuel cells, electrolyzers and reversible dual devices. Binder material is mixed with catalyst material and optionally ionomer material, and coated on support layer(s) and/or one or both side of a membrane, and the catalyst layers are hot-pressed briefly, to improve the adhesion of the layer and its cohesivity. Membrane electrode assemblies are prepared from the cell elements in various configurations of the catalyst layers with respect to the cell elements, and the added binder and hot pressing improve the long-term performance and durability of the electrochemical devices.

### CROSS REFERENCE TO RELATED APPLICATIONS

This application claims priority from Israeli Patent Application No. 297987, filed on Nov. 6, 2022, which is incorporated herein by reference in its entirety.

This application is also a Continuation-in-Part of U.S. patent application Ser. No. 18/075,490, filed Dec. 6, 2022, which is a Continuation-in-Part of U.S. patent application Ser. No. 17/830,424, filed Jun. 2, 2022, which claims the benefit of U.S. Provisional Application No. 63/211,186, filed on Jun. 16, 2021, and U.S. Provisional Application No. 63/221,035, filed on Jul. 13, 2021 and is also a Continuation-in-Part of International Application No. PCT/IL2022/050590, filed on Jun. 2, 2022. The prior applications are incorporated herein by reference in their entirety.

### BACKGROUND OF THE INVENTION

### 1. Technical Field

The present invention relates to the field of electrochemical devices, and more particularly, to configurations of membrane electrode assemblies thereof.

### 2. Discussion of Related Art

Electrolyzers and fuel cells are electrochemical devices that produce hydrogen and consume hydrogen to produce energy, respectively, which gain uses as alternative energy sources (fuel cells) and fuel sources (electrolyzers). Combined configurations provide independent sustainable energy sources that can regenerate their hydrogen supply.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a cell element that is operable in an alkaline or an anion exchange electrochemical device, the cell element coated by at least one catalyst layer that comprises a catalyst mixed with a binder and is hot pressed onto the cell element.

One aspect of the present invention provides an alkaline or an anion exchange electrochemical device with cell elements comprising a hydrogen-side electrode and an oxygen-side electrode separated by a membrane, with catalyst layers between each electrode and the membrane, wherein the catalyst layers comprise a catalyst mixed with a binder and wherein each catalyst layer is hot pressed onto an adjacent cell element.

One aspect of the present invention provides a method comprising preparing a cell element that is operable in an alkaline or an anion exchange electrochemical device, by: applying a mixture comprising a catalyst dispersion and a binder dispersion onto the cell element, and hot pressing the cell element with the applied mixture.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. The patent or application file contains at least one drawing executed in color. Copies of this patent or patent application publication with color drawing(s) will be provided by the Office upon request and payment of the necessary fee. In the accompanying drawings:

FIG. 1A is a high-level schematic illustration of an electrolyzer, according to some embodiments of the invention.

FIG. 1B is a high-level schematic illustration of a fuel cell, according to some embodiments of the invention.

FIG. 1C is a high-level schematic illustration of a dual cell, according to some embodiments of the invention.

FIGS. 1D-1H are high-level schematic illustrations of cell elements with catalyst layers that include binder material and are hot pressed, according to some embodiments of the invention.

FIGS. 1I-1L are high-level schematic illustrations of membrane electrode assemblies (MEAs) composed of disclosed cell elements with catalyst layers that include binder material and are hot pressed, according to some embodiments of the invention.

FIG. 1M is a high-level schematic illustration of a self-refueling power-generating system with reversible device(s), according to some embodiments of the invention.

FIGS. 2A-2C are high-level flowcharts illustrating methods, according to some embodiments of the invention.

FIGS. 3A and 3B provide initial experimental results related to the operation of an electrolyzer, according to some embodiments of the invention.

FIGS. 4A-4E provide initial experimental results related to the operation of a fuel cell, according to some embodiments of the invention.

FIGS. 5A and 5B provide high resolution scanning electron microscope (HRSEM) images of fuel cell ORR GDE prepared with PTFE and hot pressing, before and after operation in a fuel cell (after durability test, 450 h at 80° C. under 0.5 A/cm²), respectively, according to some embodiments of the invention, compared with FIGS. 5C and 5D that provide HRSEM images of prior art electrodes prepared without PTFE and without hot pressing according to prior art procedures, before and after operation in a fuel cell (after durability test, 310 h at 80° C. under 0.5 A/cm²), respectively.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for preparing cell elements and membrane electrode assemblies (MEAs) and thereby provide improvements to the technological field of electrochemical devices such as electrolyzers, fuel cells and combined bi-directional systems. Methods of preparing cell element(s) that are operable in alkaline or anion exchange electrochemical devices are provided, as well as corresponding cell elements and electrochemical devices such as fuel cells, electrolyzers and reversible dual devices. Binder material is mixed with catalyst material and optionally ionomer material, and coated on support layer(s) and/or one or both side of a membrane, and the catalyst layers are hot-pressed briefly, to improve the adhesion of the layer and its cohesivity. Membrane electrode assemblies are prepared from the cell elements in various configurations of the catalyst layers with respect to the cell elements, and the added binder and hot pressing improve the long-term performance and durability of the electrochemical devices. For example, methods of preparing gas diffusion electrodes (GDEs) and/or catalyst coated membranes (CCMs) for electrochemical devices such as electrolyzers and fuel cells are provided.

GDEs comprise a gas diffusion layer (GDL), and a mixture comprising a catalyst dispersion and a binder (e.g., PTFE) dispersion, applied on the GDL, wherein the GDL with the applied mixture is hot pressed to form the GDE. GDLs may be carbon-based or metal-based, and ionomer may be added to improve performance if needed. Briefly hot pressing the layer at or near the glass temperature of the binder improves the adhesion of the layer and its cohesivity, which improves its long-term performance and durability in electrolyzer and/or fuel cell applications. For example, the catalyst dispersion may comprise a catalyst dispersion and the GDE may be a hydrogen evolution reaction (HER) electrode operable in an electrolyzer. In another example, the catalyst dispersion may comprise a catalyst dispersion, the mixture may further comprise an ionomer, and the GDE may be an oxygen reduction reaction (ORR) electrode operable in a fuel cell. Certain embodiments comprise electrodes that may be operable reversibly, e.g., be used as HER/HOR electrodes and/or OER/ORR electrodes, for example in reversible devices (e.g., dual cells) that can be operated alternately in fuel cell and electrolyzer modes. Typically fuel cell electrodes may be made with carbon-based GDLs and the fuel cells may be operated with ionomeric electrolyte, while electrolyzer OER electrode may be made with metal-based GDLs and the electrolyzer may be operated with liquid electrolyte. Dual cells may be configured with carbon-based GDLs for the HER/HOR electrodes and with metal-based GDLs for the OER/ORR electrodes. Either or both types of GDEs may be prepared with binder material and be hot-pressed to improve their performance and/or durability.

CCMs may be coated on one or both sides with catalyst layers that include binder material and are hot pressed, with the catalyst layer(s) may functionally replace responsive catalyst on the adjacent support layers. For example, a catalyst layer on the hydrogen side of the membrane may replace or enhance a catalyst layer on the HER and/or HOR electrode of the device, and/or a catalyst layer on the oxygen side of the membrane may replace or enhance a catalyst layer on the OER and/or ORR electrode of the device. Disclosed CCMs may be used in fuel cells, electrolyzers and/or reversible dual devices, both in alkaline devices and in anion exchange devices (with addition of ionomer material to one or more of the catalyst layers.

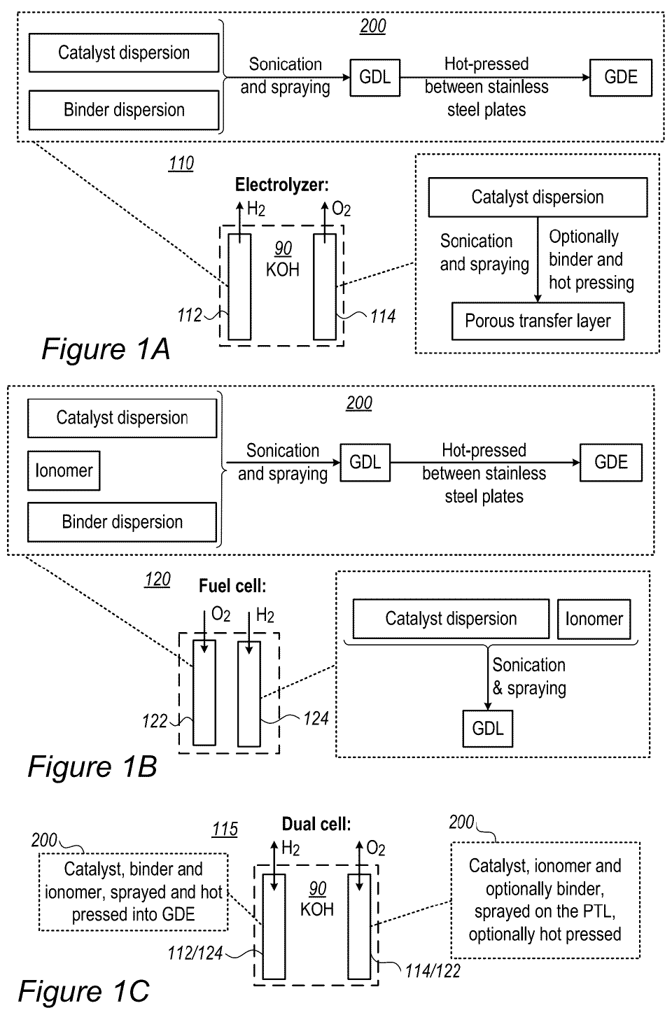

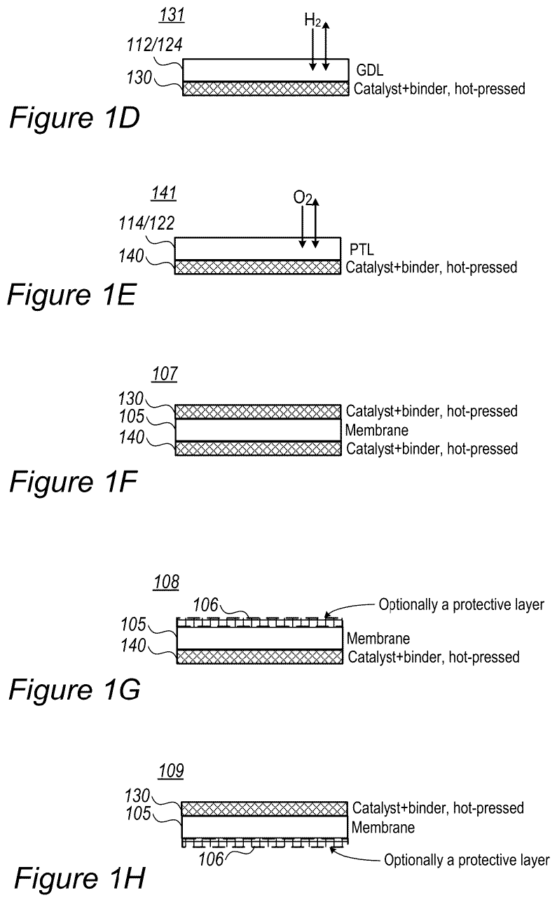

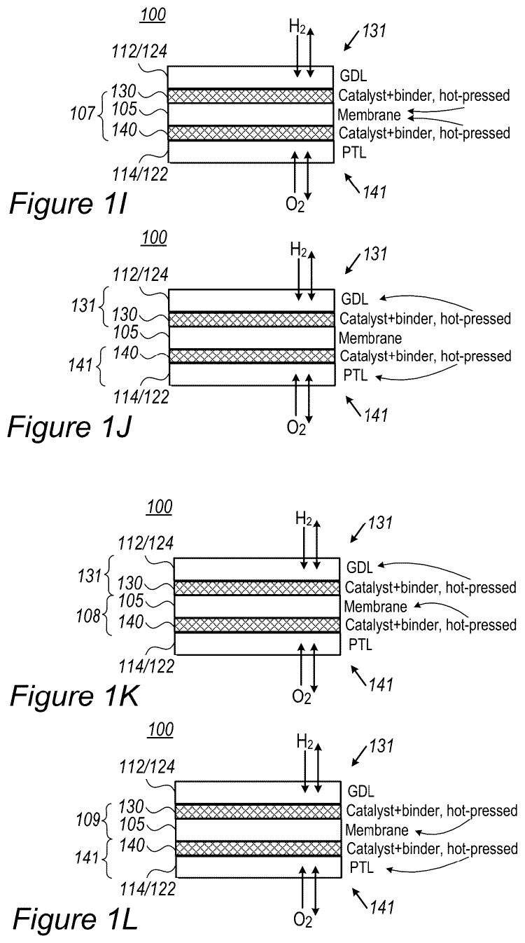

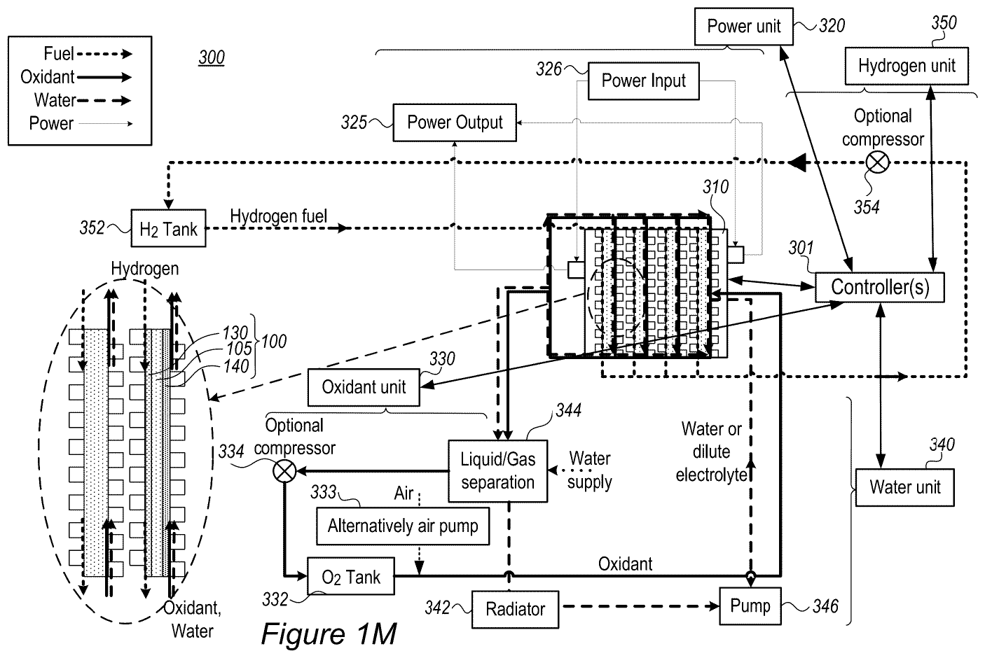

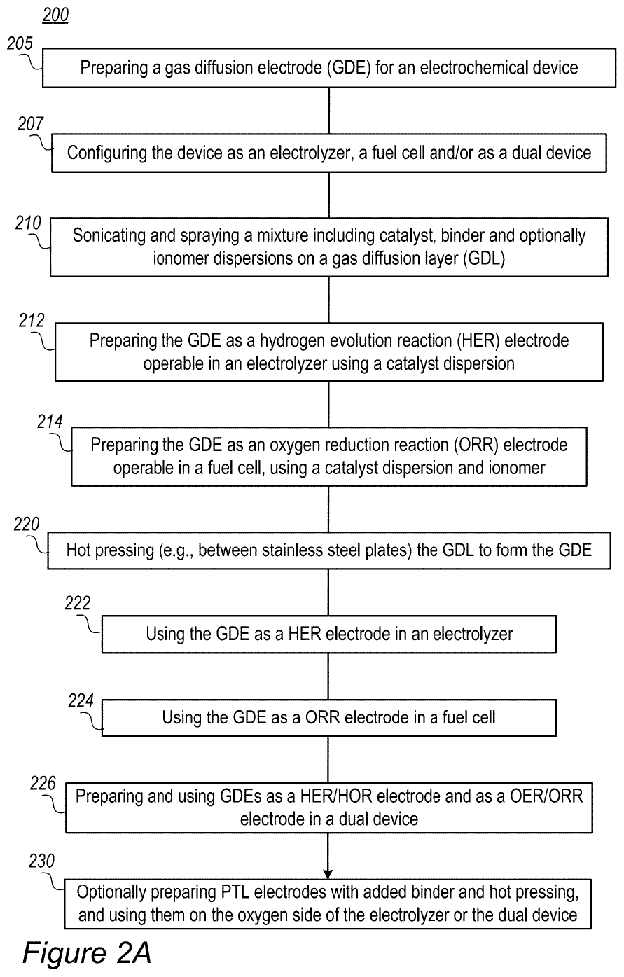

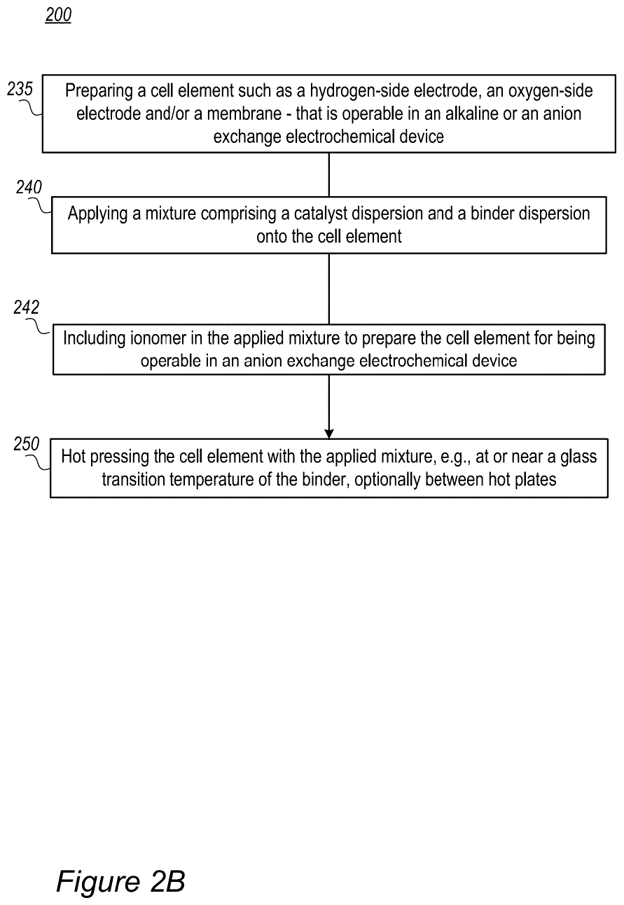

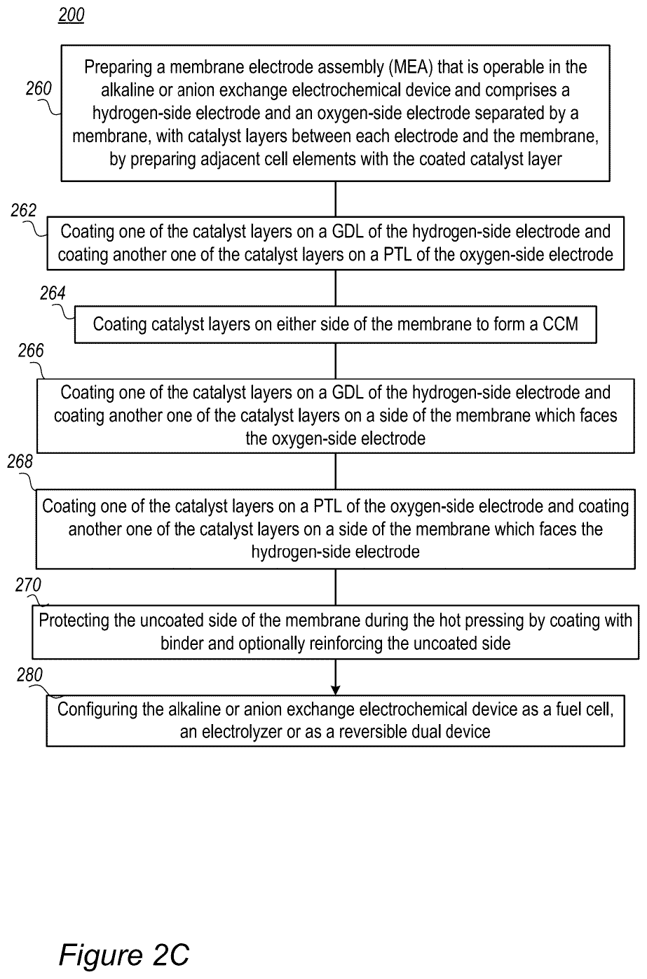

FIG. 1A is a high-level schematic block diagram of an electrolyzer 110, according to some embodiments of the invention. Electrolyzer 110 comprises GDE 112 as HER made of the GDL with the applied mixture of catalyst dispersion and binder dispersion (e.g., comprising PTFE)—hot pressed thereupon, and further comprising a catalyst-coated porous transfer layer as an oxygen evolution reaction (OER) electrode 114 and electrolyte 90. In certain embodiments, OER electrode 114 with metal-based GDL may likewise include binder material and be hot-pressed. Electrolyte 90 may be alkaline and comprise e.g., KOH, K₂CO₃ and/or KHCO₃ solutions at concentrations up to 10M (e.g., 1M, 1-5M, 3-10M or intermediate values) or may possibly comprise water (with ionomer material combined in the catalytic layer providing ionic conductivity). Methods 200 of preparing the electrodes are described below (see FIGS. 2A and 2B).

The binder material may be selected to enhance the stability and the durability of the electrode, particularly when hot pressed. Binder materials may comprise one or more materials, which have (i) low glass transition temperatures (e.g., Tg<180° C.), (ii) low swelling properties (e.g., less than 80% swelling in X-Y direction in wet conditions, at 80° C., OH— form)—to make the respective electrode mechanically stable, (iii) sufficient chemical stability at alkaline conditions (e.g., 1M KOH), (iv) prolonged thermal stability, e.g., being stable above 100° C. for at least 1000 h. Specific examples for alternative binders include chlorotrifluoroethylene, perfluoroalkoxy alkane (PFA), ethylene tetrafluoroethylene, polyvinylidene fluoride or poly (methyl-methacrylate) or any combination of these materials. In any of the disclosed embodiments, the binder material may comprise PTFE and/or any binder(s) which conform to these requirements. In any of the embodiments in which PTFE is used, PTFE may be partly or fully replaced by other types of appropriate binders. The hot-pressing temperature depends on the specific selection of binder material and ionomer type, and is typically between 110° C. and 140° C. In various examples, hot-pressing temperature may be between 110° C.-120° C., 110° C.-130° C., 120° C.-140° C., temperature values or ranges included in any of the ranges, or deviating ±10% therefrom.

In any of the disclosed embodiments, hot pressing may be optimized with respect to the type of binder and with respect to other GDE components—to yield the most stable and most efficient electrode, depending on performance requirements. For example, hot pressing may be carried out within the temperature range of 80-180° C. (depending on the Tg of the selected binder as well as on the type of ionomer and other electrode materials) and carried out for the ranges of few seconds to a few minutes (e.g., between ten seconds and ten minutes).

In non-limiting examples, a mixture of catalyst (e.g., Pt) dispersion in a solvent (e.g., 2-propanol and DI (deionized) water) and binder (e.g., PTFE) dispersion in water may be applied (e.g., sonicated and sprayed) on the GDL, which may then be pressed between plates to form GDE 112. OER electrode 114 may comprise catalyst (e.g., Ni) dispersion in the solvent (e.g., 2-propanol and DI water), applied (e.g., sonicated and sprayed) on a Ni PTL (porous transport layer). In certain embodiments, OER electrode 114 may be produced as a PTL, using binder dispersion and hot pressing, e.g., with respective catalysts/binders coated on the metal-based PTL and hot pressing for OER electrode 114. OER electrode 114 may further comprise ionomer material, or comprise catalyst and binder material (e.g., PTFE) without additional ionomer.

FIG. 1B is a high-level schematic block diagram of a fuel cell 120, according to some embodiments of the invention. Fuel cell 120 comprises GDE 122 as ORR made of the GDL with the applied mixture of catalyst dispersion, ionomer and binder (e.g., PTFE) dispersion hot pressed thereupon, and further comprising a hydrogen oxidation reaction (HOR) electrode 124. For example, HOR electrode 124 may comprises a catalyst (e.g., Pt) dispersion and ionomer, applied (e.g., sonicated and sprayed) on a HOR GDL. The ionomer material may provide ionic conductivity, without requiring electrolyte solution in fuel cell 120. Methods 200 of preparing the electrodes are described below (see FIGS. 2A and 2B).

In non-limiting examples, a mixture of catalyst (e.g., Ag) dispersion in solvent (e.g., 2-propanol and DI water), ionomer and binder (e.g., PTFE) dispersion in water may be applied (e.g., sonicated and sprayed) on the GDL, which may then be pressed between plates, for example stainless steel plates or other types of plates, to form GDE 122. HOR electrode 124 may comprise catalyst dispersion in solvent (e.g., 2-propanol and DI water) mixed with ionomer and applied (e.g., sonicated and sprayed) on a GDL.

In various embodiments, the solvent(s) may comprise, e.g., any of water, 2-propanol, ethanol, methanol, N-methyl-2-pyrrolidone, toluene, tetra-hydro-furan and/or combinations thereof with different ratios. Any of the dispersions may be formulated as an ink for the corresponding form of application.

In certain embodiments, GDEs (with carbon-based GDLs) may be used in fuel cells 120 both as ORR electrode 122 and as HOR electrode 124, with corresponding adjustments.

FIG. 1C is a high-level schematic block diagram of a dual cell 115, according to some embodiments of the invention. Dual cell 115 may be reversible, configured to operate alternately (and reversibly) as electrolyzer 110 and fuel cell 120, depending on the operation conditions of dual cell 115, namely whether electricity is provided to dual cell 115 to generate hydrogen and oxygen by electrolysis (and be operated as electrolyzer 110, with electrolyte 90 comprising water or an alkaline solution) or whether hydrogen and oxygen are delivered to dual cell 115 to generate electricity (and be operated as fuel cell 120). Correspondingly, both GDEs, namely HER/HOR electrode 112/124 and OER/ORR electrode 114/122, may be produced as disclosed herein, by spraying catalyst dispersion, binder (e.g., PTFE) and ionomer material of respective GDLs and hot pressing them to form the respective GDEs. Clearly the exact details of the catalyst type, binder (e.g., PTFE) concentration and ionomer type and concentration may be optimized to provide the required ionic conductivity and electrode stability, e.g., from the options disclosed herein, with respect to specific assembly and operation parameters of dual cell 115. In certain embodiments, OER/ORR electrode 114/122 may be produced as a PTL, using binder dispersion and hot pressing, e.g., with respective catalysts/binders coated on the metal-based PTL and hot pressing for OER/ORR electrode 114/122. OER/ORR electrode 114/122 may further comprise ionomer material, or comprise catalyst and binder material (e.g., PTFE) without additional ionomer. Methods 200 of preparing the electrodes are described below (see FIGS. 2A and 2B).

FIGS. 1D-1H are high-level schematic illustrations of cell elements with catalyst layers that include binder material and are hot pressed (200), according to some embodiments of the invention. The illustrated cell elements may be used to form various electrochemical devices, such as fuel cells 120, electrolyzers 110 and/or dual devices 115 disclosed herein.

FIG. 1D schematically illustrates hydrogen-side electrode 131 comprising GDL 112/124 which is coated by catalyst layer 130 which includes binder (e.g., PTFE) and is hot pressed as disclosed herein. GDL 112/124 may be carbon based (e.g., in fuel cell applications) or be devoid of carbon (e.g., in some electrolyzer applications). Catalyst layer 130 may optionally comprise ionomer material (e.g., in anion exchange, AEM electrochemical device applications) or be devoid of ionomer (e.g., in alkaline electrochemical device applications).

FIG. 1E schematically illustrates oxygen-side electrode 141 comprising PTL 114/122 which is coated by catalyst layer 140 which includes binder (e.g., PTFE) and is hot pressed as disclosed herein. PTL 114/122 may be metal based. Catalyst layer 140 may optionally comprise ionomer material (e.g., in anion exchange, AEM electrochemical device applications) or be devoid of ionomer (e.g., in alkaline electrochemical device applications).

FIG. 1F schematically illustrates a membrane 105 as separation layer, which is coated both sides by catalyst layers 130, 140. Either or both catalyst layers 130, 140 may include, in addition to the respective catalyst material, binder (e.g., PTFE) and optionally ionomer (for AEM devices), and the coated membrane may be hot pressed as disclosed herein to form a catalyst coated membrane (CCM) 107 for respective electrochemical devices.

FIG. 1G schematically illustrates membrane 105 as separation layer, which is coated on one side by oxygen (evolution/reduction) catalyst layer 140. Catalyst layer 140 may include, in addition to the catalyst material, binder (e.g., PTFE) and optionally ionomer (for AEM devices), and the coated membrane may be hot pressed as disclosed herein to form a one-sided CCM 108 for respective electrochemical devices. During hot pressing, the uncoated side of CCM 108 may be protected in certain embodiments by a protective layer 106, which may remain on CCM 108 or be removed after hot pressing. For example, protective layer 106 may comprise binder material only (e.g., PTFE, without catalyst material) and/or possibly mechanical reinforcement such as glass fibers.

FIG. 1H schematically illustrates membrane 105 as separation layer, which is coated on one side by hydrogen (evolution/reduction) catalyst layer 130. Catalyst layer 130 may include, in addition to the catalyst material, binder (e.g., PTFE) and optionally ionomer (for AEM devices), and the coated membrane may be hot pressed as disclosed herein to form a one-sided CCM 109 for respective electrochemical devices. During hot pressing, the uncoated side of CCM 109 may be protected in certain embodiments by a protective layer 106, which may remain on CCM 109 or be removed after hot pressing. For example, protective layer 106 may comprise binder material only (e.g., PTFE, without catalyst material) and/or possibly mechanical reinforcement such as glass fibers.

FIGS. 1I-1L are high-level schematic illustrations of membrane electrode assemblies (MEAs) 100 composed of disclosed cell elements with catalyst layers that include binder material and are hot pressed (200), according to some embodiments of the invention. MEAs 100 may be used to form various electrochemical devices, such as fuel cells 120, electrolyzers 110 and/or dual devices 115 disclosed herein.

FIG. 1I schematically illustrates MEA 100 for electrochemical devices, which includes CCM 107 disclosed herein and GDL 112/124 and PTL 114/122 on the corresponding sides of CCM 107. Illustrated MEA 100 thus includes both catalyst layers 130, 140 coated and hot pressed on membrane 105 (see schematic arrows), either of which may include, in addition to the respective catalyst material, binder material and optionally ionomer (for AEM devices). The corresponding support layers on the oxygen and hydrogen sides 131, 141 (corresponding GDL 112/124 and PTL 114/122, respectively) may be attached to CCM 107 and be devoid of catalyst layers.

FIG. 1J schematically illustrates MEA 100 for electrochemical devices, which includes coated hydrogen-side electrode 131 and coated oxygen-side electrode 141 with membrane 105 as separation layer devoid of catalyst material. Both electrodes 131, 141 are coated with corresponding catalyst layer 130, 140, binder and optionally ionomer (for AEM devices), and may be hot pressed (see schematic arrows) as disclosed herein.

FIG. 1K schematically illustrates MEA 100 for electrochemical devices, which includes one-sided CCM 108 (membrane 105 coated by catalyst layer 140 with binder and optionally ionomer, and hot pressed, as indicated by the schematic arrow) with uncoated PTL 114/122 attached to the coated oxygen side of CCM 108; and hydrogen-side electrode 131 (coated by catalyst layer 130 with binder and optionally ionomer, and hot pressed, as indicated by the schematic arrow) attached to the uncoated hydrogen side of CCM 108.

FIG. 1L schematically illustrates MEA 100 for electrochemical devices, which includes one-sided CCM 109 (membrane 105 coated by catalyst layer 130 with binder and optionally ionomer, and hot pressed, as indicated by the schematic arrow) with uncoated GDL 112/124 attached to the coated hydrogen side of CCM 109; and oxygen-side electrode 141 (coated by catalyst layer 140 with binder and optionally ionomer, and hot pressed, as indicated by the schematic arrow) attached to the uncoated oxygen side of CCM 109.

Various embodiments include fuel cells 120, electrolyzers 110 and/or dual devices 115 which comprise any of the disclosed embodiments MEAs 100, with specific configurations selected according to operational parameters such as efficiency, stability, performance and other parameters.

FIG. 1M is a high-level schematic illustration of a self-refueling power-generating system 300 with reversible devices 310, according to some embodiments of the invention. As illustrated schematically in FIG. 1M, self-refueling power-generating system 300 comprises one or more reversible device 310 comprising a stack of one or more electrochemical cells with respective membrane assemblies 100. Reversible device 310, which may comprise dual cell 115, is configured to be operated alternately as a fuel cell in a fuel cell mode and as an electrolyzer in an electrolyzer mode (see FIGS. 1A-1C). Each of membrane assemblies 100 has a hydrogen-side (131) catalyst layer 130 configured to catalyze hydrogen oxidation in the fuel cell mode and to catalyze hydrogen formation (from water electrolysis) in the electrolyzer mode and an oxidant-side (141) catalyst layer 140 configured to catalyze oxygen reduction in the fuel cell mode and to catalyze oxygen formation (from water electrolysis) in the electrolyzer mode. Catalyst layers 130, 140 may be arranged in pairs and be separated by a separation layer (membrane) 105 that allows ion transfer therethrough, anions in AEM configurations. Separation layer (membrane) 105 may comprise a single layer, a composite layer, or multiple layers, each of which may be simple or composite, as disclosed herein. System 300 further comprises one or more controller 301 configured to determine operation of reversible device 310 in the fuel cell mode or in the electrolyzer mode.

The stack may comprise a single bifunctional stack with a plurality of electrochemical cells with respective membrane assemblies 100, that functions, as a single stack, in both fuel cell and electrolyzer operation modes. In various embodiments, the stack may comprise two, three, five, ten, twenty, fifty or more cells, or an intermediate number of cells.

Membrane assemblies 100 may comprise single layered or multi-layered solid state polymer membranes. For example, polymer membranes may be based on an ion-conducting polymer, and be able to transport water and anions and/or cations from one electrode to the other during operation. Membrane assemblies 100 may comprise (i) at least one catalyst layer comprising, on an oxygen side 141 of membrane assembly 100: oxygen generating catalyst layer(s), oxygen reducing catalyst layer(s) and/or bifunctional catalyst layer(s) capable of oxygen generation as well as oxygen reduction; and (ii) at least one catalyst layer comprising, on a hydrogen side 131 of membrane assembly 100: hydrogen generating catalyst layer(s), hydrogen oxidizing catalyst layer(s) and/or bifunctional catalyst layer(s) capable of hydrogen generation as well as hydrogen oxidation.

It is noted that either of catalyst layers 131, 141 may comprise one or more materials, and may include different materials to support the opposite catalytic reactions. For example, catalyst layer of oxygen-side electrode 140 on oxygen side 141 may comprise one or more materials to generate oxygen and one or more same or different materials to reduce oxygen, while catalyst layer of hydrogen-side electrode 130 on hydrogen side 131 may comprise one or more materials to generate hydrogen and one or more same or different materials to oxidize hydrogen. It is further noted that catalyst materials for one direction of operation (fuel cell mode or electrolysis mode) may be more efficient than the catalyst materials for the opposite direction of operation, depending, e.g., on the expected operation profile of reversible system 300 (e.g., on the required power supply rate and/or on the hydrogen refilling rate). It is further noted that other than prior art such as U.S. Patent Application Publication No. 20130146471, multiple catalyst materials may be integrated in a single respective catalyst layer that is operative in both reaction directions, in both fuel cell mode and electrolysis mode, and are not separated into two or more distinguishable layers. Examples for catalyst materials are provided below.

Self-refueling power-generating system 300 further comprises an oxidant unit 330 configured to supply oxygen or air to reversible device 310 when operated in fuel cell mode, and optionally receive oxygen from reversible device 310 when operated in electrolyzer mode. Optionally, oxidant unit 330 may comprise an oxygen tank 332 for storing oxygen and may comprise a compressor 334 for compressing oxygen received from AEM device 310 into oxygen tank 332. Alternatively, oxygen compression may be provided by AEM device 310 during its operation as an electrolyzer in the electrolyzer mode. Supplying pure oxygen to oxygen-side electrode 140 during power generation in fuel cell mode may increase the efficiency of system 300 as well as simplify system 300 by making use of the oxygen produced together with hydrogen generation in the electrolyzer mode—possibly yielding a closed oxygen circuit. If needed, any of an additional pump, a CO₂ filter and/or a humidification unit may be included in the closed oxygen circuit.

Self-refueling power-generating system 300 further comprises a hydrogen unit 350 configured to supply hydrogen to reversible device 310 when operated in fuel cell mode, and optionally receive hydrogen from reversible device 310 when operated in electrolyzer mode. Optionally, hydrogen unit 350 may comprise a hydrogen tank 352 for storing hydrogen and may comprise a compressor 354 for compressing hydrogen received from AEM device 310 into hydrogen tank 352. In electrolyzer mode, the generated hydrogen may be passed through a drying unit (not shown) and compressed, optionally electrochemically within AEM device 310, or optionally with the use of a mechanical, electrochemical or other compressor 354.

Self-refueling power-generating system 300 further comprises a water unit 340 configured to supply water (indicated schematically) and/or dilute electrolyte to reversible device 310. Water unit 340 may comprise a radiator 342 for dissipating heat and condensing water from reversible device 310 in the fuel cell mode, a liquid/gas separation module 344 for removing gases such as oxygen from the fluids received from reversible device 310 and a water pump 346 for pumping water to reversible device 310. Dilute alkaline electrolyte (e.g., at concentration lower than 3M) and/or deionized water may be circulated to control the operation temperature. The water circulation may be controlled to maintain the optimal operation temperatures in the fuel cell and electrolyzer modes. The circulated water or alkaline water may be supplied directly to oxygen side 141 (adjacent to oxygen-side catalyst layer 140) via a circulation circuit which also serves as the water supply for hydrogen generation in the electrolyzer mode. Water that is generated by consumption of hydrogen during power generation in the fuel cell mode, may optionally be separated from the reactant gas/gases and returned to the water circulation circuit to replenish any water consumed during the hydrogen generation in the electrolyzer mode. Supply of water or dilute electrolyte to reversible device 310 may be carried out in a closed circuit and in conjunction with the supply of oxygen to reversible device 310.

In certain embodiments, gas/liquid separation module 344 may be configured to deliver separated oxygen from reversible device 310 (produced in electrolyzer mode) to oxidant unit 330, e.g., to compressor 334 and stored in an oxygen tank 332 (or alternatively using an air pump 333 for pumping, e.g., ambient air to supply oxidant). Water circulation may be provided directly to oxygen side 141 of reversible device 310 and the water may optionally be made alkaline by the addition of KOH or other alkaline salt, which may improve performance of reversible device 310. By combining the water and oxygen in the oxygen electrode, local relative humidity may be fixed at 100% due to the presence of excess liquid water. It is noted that while water consumption in the electrolyzer mode and water production in the fuel cell mode of reversible device 310 balance each other, some addition of water may be required due to system losses. A balance between oxygen and water supply may be controlled by controller 301 to optimize fuel cell performance, e.g., by using pure oxygen, and/or hydrophobizing or partially hydrophobizing the oxygen side catalyst layer and/or diffusion medium in membrane assembly 100, to preserve some areas free or partially free of liquid water and thereby allowing good access of the reactant oxygen to the catalyst surface. Water or dilute electrolyte may be stored in liquid/gas separation tank 344 or in an additional tank. A water supply line may optionally be included in system 300 to assure that the water supply is not depleted. In both power generation and hydrogen generation modes, the water continues to function as the temperature controlling fluid, and is still passed through the radiator to dissipate excess heat generated by either device.

Advantageously, by capturing the water generated in the fuel cell mode and the oxygen (in addition to the hydrogen) generated in the electrolyzer mode, system 300 may be entirely self-contained without need of any external supply of hydrogen, water or air/oxygen, needing only external power input 326 for refueling (hydrogen generation in the electrolyzer mode), thus retaining one of the key benefits of battery-based power systems while allowing a conceptually unlimited amount of energy capacity without the need for a larger device, a capability unavailable to battery systems.

Self-refueling power-generating system 300 further comprises a power connection unit 320 configured to receive power from reversible device 310 when operated in the fuel cell mode, e.g., as power output 325; and to deliver power to reversible device 310 when operated in an electrolyzer mode, e.g., as power input 326. Power connection unit 320 may be configured to deliver the received power to an external load when required, and to receive power for delivery from an external source when available. In various embodiments, power input 326 may be received from various sources, such as an electric grid, renewable energy resources and/or batteries, possibly selected according to their respective time-dependent cost and availability. For example, power input 326 may be selected from solar panels or wind turbines when these are available, according to method 400 disclosed herein. Self-refueling power-generating system 300 may be used as any of a backup electrical power generation system, portable power generation system or any other power generation system that is entirely independent of normal user intervention for refueling operations, but rather self-recharges whenever the fuel storage unit is not full and an external electrical power supply is available. Certain embodiments comprise a grid setup comprising a plurality of independent systems 300, that may use separate or shared hydrogen fuel storage 352, and optional oxygen storage 332, optional battery banks and power sources 326 to provide a localized independent power supply solution to the users of that grid.

FIG. 2A is a high-level flowchart illustrating a method 200, according to some embodiments of the invention. The method stages may be carried out with respect to the disclosed GDEs, electrolyzers 110, fuel cells 120 and/or dual devices 115 described above, which may optionally be configured to implement method 200. Method 200 may comprise the following stages, irrespective of their order.

Method 200 may comprise preparing a gas diffusion electrode (GDE) for an electrochemical device (stage 205), the method comprising: sonicating and spraying a mixture on a gas diffusion layer (GDL), wherein the mixture comprises a catalyst dispersion and a binder dispersion (stage 210), and hot pressing the GDL to form the GDE (stage 220), for example at the glass transition temperature of the binder, and e.g., between plates.

In certain embodiments, method 200 may comprise preparing the GDE using a catalyst dispersion (stage 212), e.g., Pt, and using the GDE as a hydrogen evolution reaction (HER) electrode operable in an electrolyzer (stage 222), e.g., with a catalyst-coated porous transport layer (PTL) as an OER electrode and KOH electrolyte.

In certain embodiments, method 200 may comprise preparing the GDE using a catalyst (e.g., Ag) dispersion and ionomer (stage 214) and using the GDE as an oxygen reduction reaction (ORR) electrode operable in a fuel cell (stage 224), e.g., with a catalyst (e.g., Pt) dispersion and ionomer, sonicated and sprayed on a HOR GDL and KOH electrolyte.

In certain embodiments, method 200 may comprise configuring the device as an electrolyzer, fuel cell and/or a dual device (stage 207), with respective GDEs as ORR electrodes for fuel cells, HER electrodes for electrolyzers and/or preparing and using GDEs as a HER/HOR electrode and as a OER/ORR electrode in a dual device (stage 226). Method 200 may thus comprise using the GDEs to form a dual cell, that is operable alternately as an electrolyzer and as a fuel cell (with both GDEs including ionomer).

In various embodiments, disclosed uses of binder and hot pressing may be applied to one or both types of electrodes in each type of device. For example, in fuel cells, only ORR electrode or both ORR and HOR electrodes may be produced using binder dispersion and hot pressing, e.g., with respective catalysts/binders coated on respective carbon-based GDLs. In electrolyzers, only HER electrode or both HER and OER electrodes may be produced using binder dispersion and hot pressing, e.g., with respective catalysts/binders coated on carbon-based GDL for the HER electrode and on metal-based PTL for the OER electrode. In dual systems, the OER/ORR (on metal-based PTL) electrodes and the HER/HOR (on carbon-based GDL) electrodes may be produced using binder dispersion and hot pressing as disclosed herein. Specifically, in certain embodiments, PTL electrodes may be prepared with added binder and hot pressing, and be used on the oxygen side of the electrolyzer or the dual device (stage 230).

FIGS. 2B and 2C are high-level flowcharts illustrating methods 200, according to some embodiments of the invention. The method stages may be carried out with respect to any of disclosed electrodes 131, 141, membranes 107, 108, 109, MEAs 100, electrolyzers 110, fuel cells 120 and/or dual devices 115 disclosed herein, which may be prepared by stages of methods 200. Methods 200 may comprise any of the following stages and/or any of the stages disclosed in FIG. 2A, irrespective of their order.

FIG. 2B illustrates schematically methods 200 of preparing a cell element that is operable in an alkaline or an anion exchange electrochemical device (stage 235), by: applying a mixture comprising a catalyst dispersion and a binder dispersion onto the cell element (stage 240), e.g., by sonicating and spraying the mixture onto the cell element; and hot pressing the cell element with the applied mixture (stage 250), e.g., at or near a glass transition temperature of the binder, optionally between hot plates. In various embodiments, the cell element may be a hydrogen-side electrode, an oxygen-side electrode and/or a membrane of the electrochemical device. The catalyst dispersion may comprise particles of at least one of: Pt, Ag, Ir, Pd, Ru, Ni, Co, Fe, Pd and their alloys, mixtures, oxides or mixed oxides, and the binder dispersion may comprise particles of at least one of: PTFE, CTFE, PFA, ETFE, PVDF, and PMMA.

In certain embodiments, method 200 may further comprise including ionomer in the applied mixture to prepare the cell element for being operable in an anion exchange electrochemical device (stage 242).

The hot-pressing temperature depends on the specific selection of binder material and ionomer type, and is typically between 110° C. and 140° C. In various examples, hot-pressing temperature may be between 110° C.-120° C., 110° C.-130° C., 120° C.-140° C., temperature values or ranges included in any of the ranges, or deviating ±10% therefrom.

FIG. 2C illustrates schematically methods 200 of preparing a membrane electrode assembly (MEA) that is operable in the alkaline or anion exchange electrochemical device and comprises a hydrogen-side electrode and an oxygen-side electrode separated by a membrane, with catalyst layers between each electrode and the membrane, by preparing adjacent cell elements with the coated catalyst layer (stage 260). The cell elements may be prepared as in stage 235 and methods 200 disclosed in FIG. 2B.

In some embodiments, method 200 may comprise coating one of the catalyst layers on a GDL of the hydrogen-side electrode and coating another one of the catalyst layers on a PTL of the oxygen-side electrode (stage 262). The GDL and PTL thus form GDEs on either side of the uncoated membrane.

In some embodiments, method 200 may comprise coating catalyst layers on either side of the membrane to form a CCM (stage 264). Support layers on either side of the CCM (e.g., GDL and PTL) are provided to complete the MEA, with the catalytic layers applied onto the membrane.

In some embodiments, method 200 may comprise coating one of the catalyst layers on a GDL of the hydrogen-side electrode and coating another one of the catalyst layers on a side of the membrane which faces the oxygen-side electrode (stage 266). A support layer on the oxygen side (e.g., PTL) is provided to complete the MEA, with the oxygen catalytic layer applied onto the membrane.

In some embodiments, method 200 may comprise coating one of the catalyst layers on a PTL of the oxygen-side electrode and coating another one of the catalyst layers on a side of the membrane which faces the hydrogen-side electrode (stage 268). A support layer on the hydrogen side (e.g., GDL) is provided to complete the MEA, with the hydrogen catalytic layer applied onto the membrane.

In various embodiments, method 200 may further comprise protecting the uncoated side of the membrane during the hot pressing by coating it with binder and optionally reinforcing the uncoated side of the membrane (stage 270).

In various embodiments, method 200 may further comprise configuring the alkaline or anion exchange electrochemical device as a fuel cell, an electrolyzer or as a reversible dual device (stage 280), e.g., by selecting corresponding catalysts and configurations.

In various embodiments, the catalyst dispersion may comprise one or more of: Pt, Ag, Ir, Pd, Ru, Ni, Co, Fe, Pd and their alloys, mixtures, oxides or mixed oxides, and the binder may comprise one or more of: polytetrafluoroethylene (PTFE), chlorotrifluoroethylene (CTFE), perfluoroalkoxy alkane (PFA), ethylene tetrafluoroethylene (ETFE), polyvinylidene fluoride (PVDF) and poly (methyl-methacrylate) (PMMA). For example, the catalyst dispersion may comprise Pt and the binder may comprise PTFE. In another example, the catalyst dispersion may comprise Ag and the mixture may comprise an ionomer.

In some embodiments, the hydrogen electrode may comprise a carbon-based HER GDL and the oxygen electrode may comprise a metal-based OER PTL.

In various embodiments, catalyst dispersion for either electrode may include other types of catalysts, such as other members of the platinum group metals (PGMs), non-supported or supported on carbon. For example, the hydrogen-side catalyst layer may include ionomer(s) with embedded hydrogen oxidizing and/or hydrogen evolving (generating) catalyst particles such as nanoparticles made of any of Pt, Ir, Pd, Ru, Ni, Co, Fe, Pd—CeO_{X} and their alloys, blends and/or combinations, optionally supported on carbon or other conducting substrates. Alternatively or complementarily, the hydrogen-side catalyst layer may comprise modified carbons with embedded catalytic groups such as nitrides or various transition metals. Alternatively or complementarily, the hydrogen-side catalyst layer may comprise transition metal oxides or hydroxides based on Ni, Co, Mn, Mo, Fe, etc., nitrogen-doped and/or metal-doped carbon materials. The hydrogen-side catalyst layer may have an ionomer content of between 0% to 40% w/w (or within subranges such as 0% to 10% w/w, 5% to 20% w/w, 10% to 30% w/w, 20% to 40% w/w, or other intermediate ranges). The hydrogen-side catalyst layer may be configured to be stable over the full voltage range of electrode operation, e.g., from under about −0.2 V in electrolyzer mode to over about +0.4V in fuel cell mode, versus a reversing hydrogen electrode. In non-limiting examples, the oxygen-side catalyst layer may include ionomer(s) with embedded cathode catalyst particles such as nanoparticles made of oxygen reducing and/or oxygen evolving (generating) catalysts made of any of NiFe₂O₄, Perovskites, Fe, Zn, Ag, Ag alloyed with Pt, Pd, Cu, Zr, Ag, Ni, Fe, Mn, Co, Pt, Ir, Ru their alloys, blends and/or combinations, possibly combined with metal oxides such as, e.g., cerium oxide, zirconium oxide, their alloys, blends and/or combinations. Alternatively or complementarily, the oxygen-side catalyst layer may comprise the metal particles in oxide or hydroxide form and/or include surface oxide or hydroxide layers. Alternatively or complementarily, the oxygen-side catalyst layer may comprise transition metal(s), metal oxide(s) and/or metal hydroxide(s) that are based on Ni, Fe, Co, Mn, Mo and their alloys, mixed oxides or mixed hydroxides such as spinel, perovskite or layered double hydroxide (LDH) structures, potentially doped with or loaded with Pt, Ir, Ru, Ag or other elements to enhance oxygen generation and/or reduction performance.

Gas diffusion layer(s) (GDLs) and/or may include any type of gas diffusion layers such as carbon paper, non-woven carbon felt, woven carbon cloth and the like, nickel, titanium or stainless steel meshes, felts, foams, sintered microspheres, or other porous and electrically conductive substrates. In some embodiments, the GDLs may be attached to a microporous layer (MPL), made, e.g., from sintered carbon and/or optionally polytetrafluoroethylene (PTFE) or other hydrophobic particles, or from various porous metallic or other porous conductive layers.

In various embodiments, the PTL (porous transport layer) may be made of the following materials: Ni, various grades of stainless steel, titanium or any combination of all of them together. In addition, it can be either felt, mesh, or dual layers, with different porosity values and different thicknesses. The PTL may be used with or without a mesoporous layer (MPL).

In non-limiting examples of AEM implementations, the ionomeric material matrix may comprise a continuous anion conducting ionomer comprising, e.g., polyolefin(s), polyphenylene(s) and/or polysulfones. The continuous anion conducting ionomer may further comprise polymers or copolymers of (vinylbenzyl)trimethylammonium chloride, wherein the chloride counterion may be exchanged to any desired anion, copolymers of diallyldimethylammonium chloride (DADMAC), wherein the counterion may be exchanged to any desired anion, styrene-based polymers having quaternary ammonium anion conducting group, quaternized poly(vinylalcohol) (QPVA), bi-phenyl or tri-phenyl backboned polymers with one or more functional groups that could include alkyl tether group(s) and/or alkyl halide group(s) and/or equivalent groups, poly(arylpiperidinium) and other polymers containing cyclic quaternary ammonium in the backbone or on tethered sidechains, poly(bis-arylimidazoliums), cation-functionalized poly(norbornenes), neutral polymers or polymer membranes with grafted anion-conductive sidechains, or any other anion-conducting polymer. In some embodiments, the anion conducting ionomer may be crosslinked, e.g., using crosslinking agent(s) selected according to the type of the ionomer to be crosslinked, such as divinylbenzne, N,N,N′,N′-tetramethyl-1,6-hexanediamine (TMHDA), 1,4-diazabicyclo[2.2.2]octane (DABCO), glyoxal, glutaraldehyde, styrene based polymer(s) having quaternary ammonium anion conducting group(s), bi-phenyl or tri-phenyl backboned with one or more functional groups that could include alkene tether group(s) and/or alkyl halide group(s) and/or equivalent groups, hydrocarbon chains, sulfur groups, siloxy groups, N-hydroxybenzotriazole groups, azide groups and the like. In some embodiments, the anion conducting ionomer may be a blend of several polymers, some of which may not be anion conducting.

Non-limiting examples and experimental results are provided in the following. In these examples, the combination of using binder material and brief hot-pressing was used to enhance the performance of the respective electrodes with respect to their stability and durability. GDEs with 5 cm² active area were prepared and tested in respective sealed electrolyzer and fuel cell configurations.

In the electrolyzer configurations, catalyst dispersion was applied to yield a loading of 0.17 mg/cm² on the HER GDE. The PTFE dispersion had a 60% wt % and 1.5 gr/ml density (in water) with particle size between 0.05-0.5 μm. Mixtures with PTFE content ranging between 3 wt %, 6 wt % and 10 wt % were compared. The mixture was sonicated for 15 minutes and sprayed by a spray gun on Freudenberg carbon paper GDLs, and then hot-pressed at 119° C. to change the PTFE to amorphous structure near its Tg (glass transition temperature). The hot-pressing temperature depends on the specific selection of binder material and ionomer type, and is typically between 110° C. and 140° C. In various examples, hot-pressing temperature may be between 110° C.-120° C., 110° C.-130° C., 120° C.-140° C., temperature values or ranges included in any of the ranges, or deviating ±10% therefrom. The Ni PTL OER electrode was prepared in a similar manner of spraying, without using PTFE, ionomer or applying hot pressing. The electrolyzer cells were assembled using Ni200 flow fields, stainless steel end plates, 50 μm PTFE sub-gaskets and 250/160 μm thick PTFE gaskets at the cathode/anode sides, respectively, sealed under a torque of 7 Nm.

In the fuel cell configurations, the catalyst dispersion was applied to yield a loading of 2.5 mg/cm² on the ORR GDE, with a 4 wt % commercial ionomer. The PTFE dispersion had a 60% wt % and 1.5 gr/ml density (in water) with particle size between 0.05-0.5 μm and an overall PTFE content of 3 wt %. The HOR electrode was prepared in a similar manner of spraying a mixture of catalyst dispersion applied to yield a loading of 1.4 mg/cm² and including 12 wt % commercial ionomer. Both mixtures were sonicated for 15 minutes and sprayed by a spray gun on Freudenberg nonwoven carbon GDLs with microporous layer. The ORR GDE was hot-pressed at 119° C. for 3 minutes at a pressure of 106 kg/cm², to change the PTFE to amorphous structure at its Tg (glass transition temperature). The fuel cells were assembled and sealed using 200 μm thick Kapton polyimide gaskets on both electrodes, under a torque of 7 Nm.

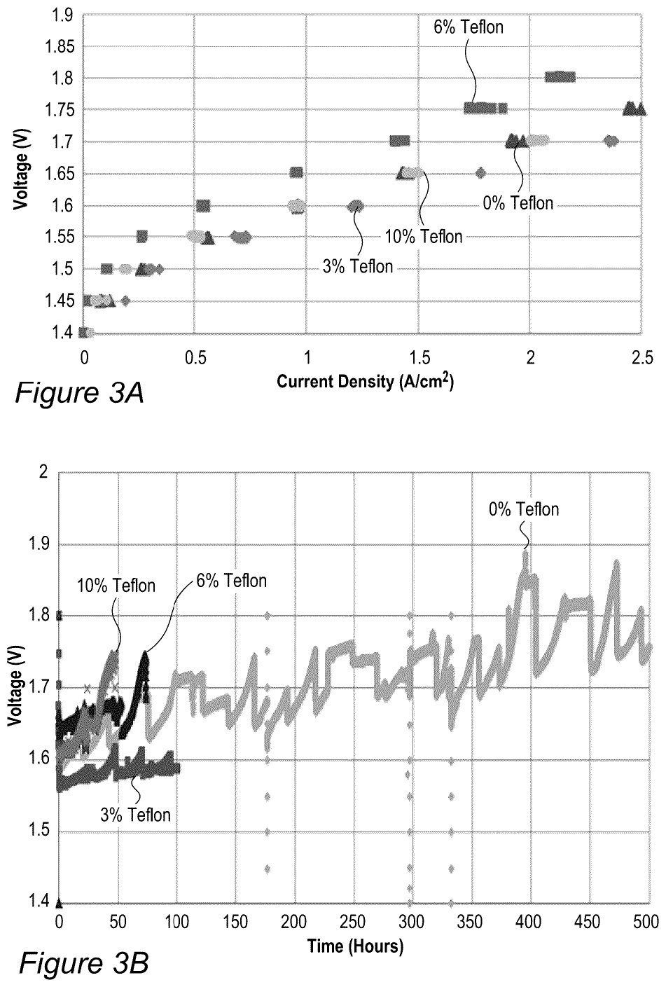

FIGS. 3A and 3B provide initial experimental results related to the operation of electrolyzer 110, according to some embodiments of the invention. FIG. 3A indicates the performance and FIG. 3B illustrates the durability of electrolyzer 110 having HER GDE 112 prepared from mixtures having no PTFE (0% PTFE content as comparison) and mixtures having PTFE content of 3 wt %, 6 wt % and 10 wt %. The results were measured for electrolyzers 110 described above, operating HER GDE 112 at 60° C. under 170 ml/h flow of 1M KOH electrolyte, while OER electrode 114 was operated at room temperature without flow of electrolyte. It is noted that in this experiment, in a non-limiting manner, KOH was pumped only to the anode side, from which the KOH penetrated through the membrane and reached the cathode side. In a performance experiment (FIG. 3A) the resulting current density (corresponding to the hydrogen production level) was measured with respect to the applied voltage, while in a durability experiment (FIG. 3B) a constant level of current density (1 A/cm²) was applied, which corresponds to a constant level of hydrogen production.

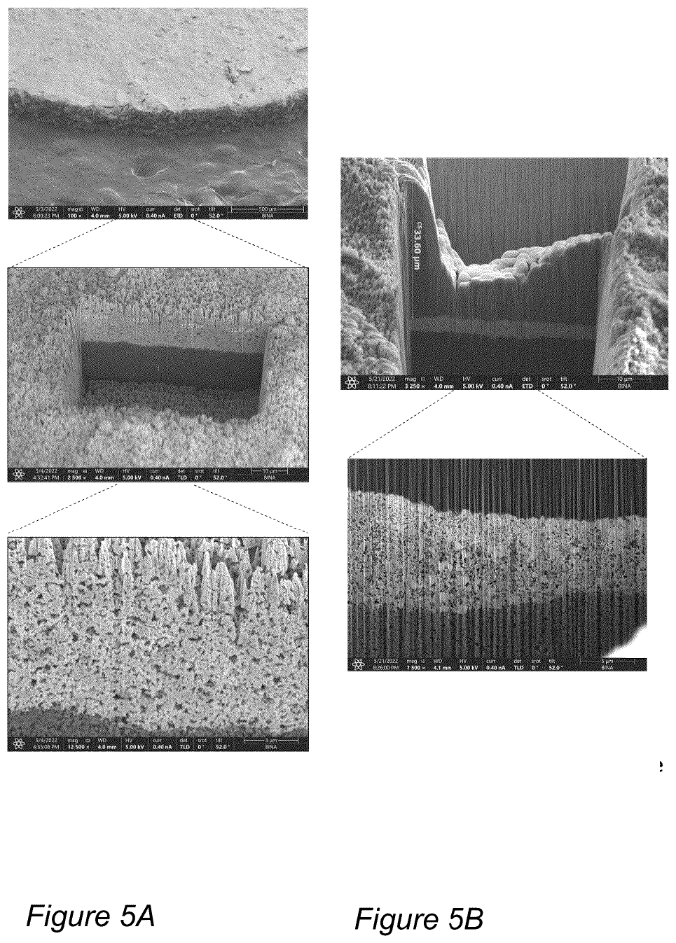

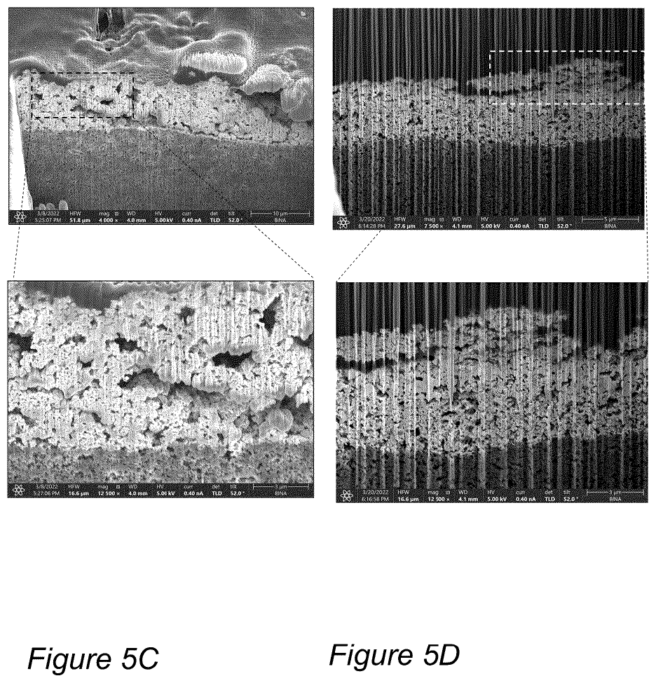

In FIG. 3A, for a given voltage, the efficiency of electrolyzer 110 is higher (greater hydrogen production) with higher current density, indicating maximal performance at a PTFE content of 3 wt %, which is better than no PTFE. In FIG. 3B, the increase in voltage level (for the same current density) indicates the degradation of HER GDE 112, indicating maximal durability at a PTFE content of 3 wt %. The inventors suggest that the intermediate level of PTFE content provides on the one hand a more stable GDE layer having better adhesion to the GDL (see also FIGS. 5A-5D for corresponding SEM images of fuel cell cathodes) while, on the other hand, not making the GDE too hydrophobic as to reduce the permeation of the liquid KOH electrolyte and of the gaseous oxygen release, which might have occurred at higher PTFE content. Clearly, the optimal PTFE content depends on the production and operation conditions of electrolyzers 110 and may change for different designs.

For example, it is noted however, that while PTFE makes the layer more hydrophobic and therefor requires longer time to equilibrate with the KOH electrolyte (that may lead to initial lower performance), in the long term the PTFE increases the durability of the layer, so there is some trade-off between initial performance and durability, which may be optimized in different ways, with different PTFE content, depending on details of production and use. Additional considerations involve the different effects of adding PTFE at different current densities, the possibility to include both PTFE and ionomer in the catalyst layer, which make the considerations and optimization more complex—(enhancing conductivity, but increasing sensitivity to the hot press parameters), and possibly requiring modification of catalyst loading. Accordingly, parameters of PTFE application and hot pressing may be modified and optimized with respect to the electrode composition and performance requirements. On the other hand, it is noted that replacing some or all of the ionomer in the electrode with PTFE may provide benefits such as less or no degradation in alkaline environment (as might occur to the functional groups of the ionomer) and reduction or prevention of swelling and of leaching out of the catalyst during operation, which are main causes for reduced lifetime and performance.

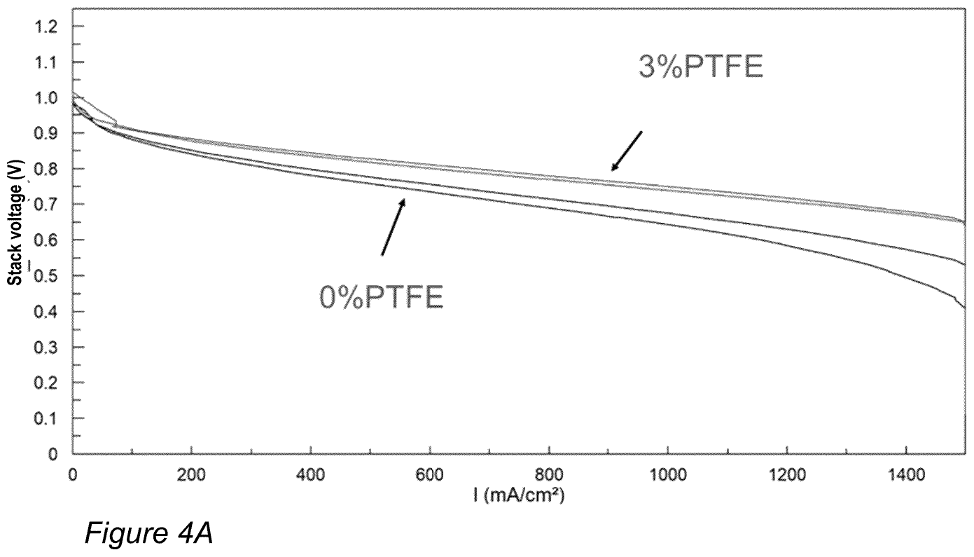

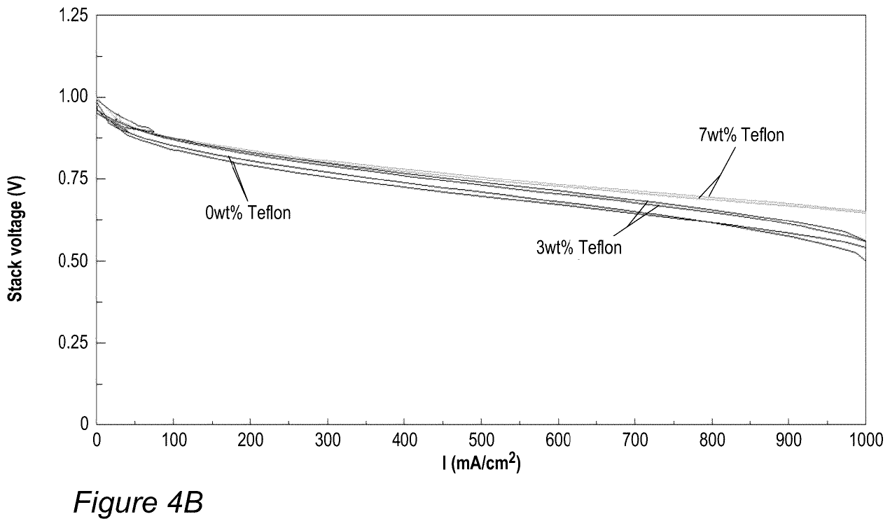

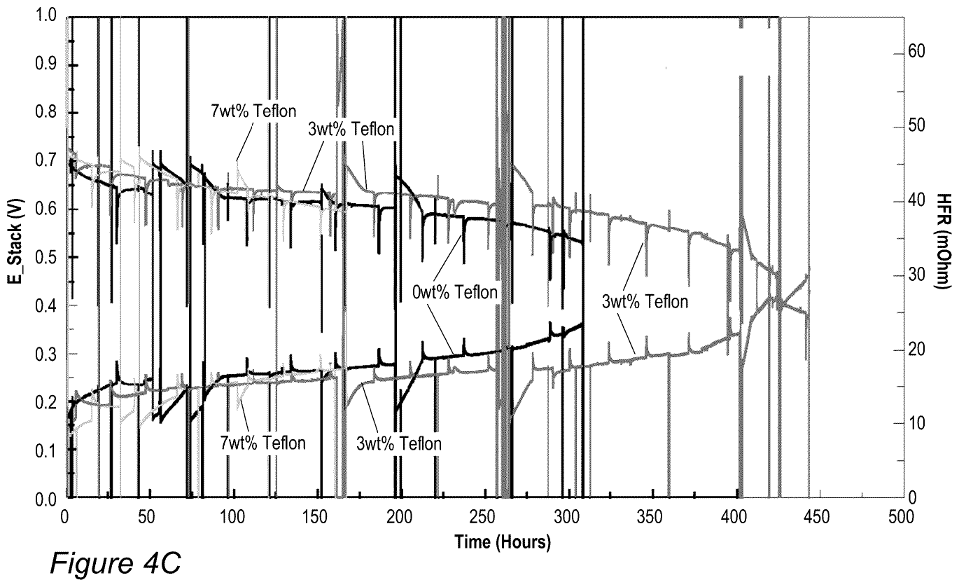

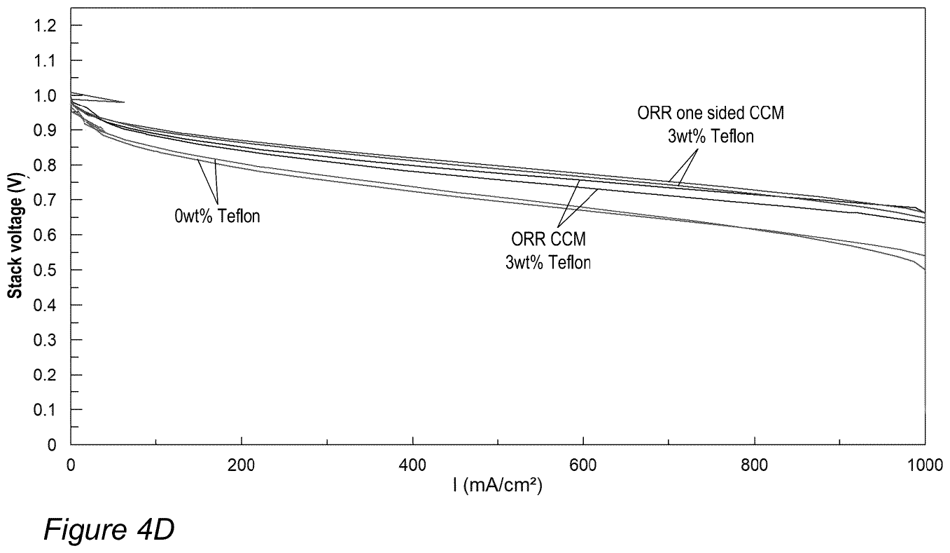

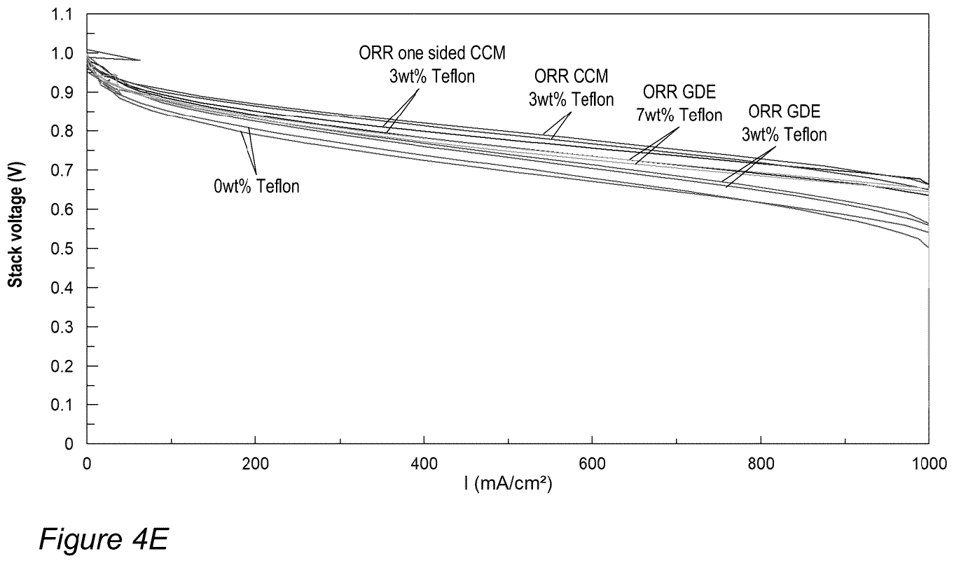

FIGS. 4A-4E provide initial experimental results related to the operation of fuel cell 120, according to some embodiments of the invention.

FIG. 4A indicates the initial performance of a CCM configuration 107 with 3% binder (3 wt % PTFE, Teflon®) and hot pressing, compared to a CCM without binder hot-press treatment (0%), indicating higher fuel cell efficiency over the entire current density range, when using disclosed embodiments.

FIG. 4B indicates the initial performance of different configurations and FIG. 4C illustrates the durability of fuel cell 120 having ORR GDE 122 (as oxygen side electrode 141) prepared from mixtures having no PTFE (0% PTFE content as comparison) and mixtures having PTFE content of 3 wt % and 7 wt %. The results were measured for fuel cells 120 described above, operated at 80° C. The dew point for ORR GDE 122 was 76° C. and the back pressure 1 barg (gauge pressure); the dew point for HOR electrode 124 was 67° C. and the back pressure (BP) 3 barg (note, the non-limiting experimental application of back pressure to the H₂ side increases the water transport through the layer). In an initial performance experiment (FIG. 4B) air flow to ORR GDE 122 was 1 l/min and H₂ flow to HOR electrode 124 was 0.15 l/min; in a durability experiment (FIG. 4C) air flow to ORR GDE 122 was 0.2 ml/min and H₂ flow to HOR electrode 124 was 0.07 ml/min, while the current density was 0.5 A/cm² (the lower flow in the durability tests are in order to keep the MEA—membrane electrode assembly, from dry-out). In FIG. 4B, the efficiency of fuel cell 120 with PTFE content of 7 wt % in ORR GDE 122 was the highest over the entire current density range. In FIG. 4C, the lowest rate of degradation was in fuel cell 120 with PTFE content of 3 wt % in ORR GDE 122. The inventors suggest that the intermediate level of PTFE content provides on the one hand a more stable GDE layer having better internal adhesion and adhesion to the GDL (see also FIGS. 5A-5D for corresponding SEM images) while, on the other hand, maintaining sufficient ionic conductivity via the ionomer in the GDE, avoiding too much interference by the PTFE material.

FIG. 4D indicates the initial performance of a CCM configuration 107 with 3% binder (3 wt % PTFE, Teflon®) and hot pressing, and of a one-sided CCM configuration (with oxygen side catalyst) 108 with 3% binder (3 wt % PTFE, Teflon®) and hot pressing—compared to a CCM without binder hot-press treatment (0%). The CCM configurations were tested as described above, in a fuel cell operated at 80° C. The dew point for the ORR electrode was 76° C. and the back pressure 1 barg (gauge pressure); the dew point for the HOR electrode was 67° C. and the back pressure (BP) 3 barg. The air flow to the ORR electrode was 1 l/min and the H₂ flow to the HOR electrode was 0.15 l/min. The results indicate that both configurations provide higher efficiency over the entire current density range, when using disclosed embodiments.

FIG. 4E compares the results for GDE configurations and CCM configurations described in FIGS. 4B and 4D, and indicate the higher efficiency over the entire current density range, when using disclosed embodiments, with some advantage to the CCM configurations (one and two sided) over the GDE configurations under these conditions.

In cases in which the method of adding PTFE and hot pressing the electrode are carried out for electrodes that include ionomer material (e.g., in anion exchange devices), the inventors have noted that carrying the process out when the ionomer includes HCO₃⁻ as counter ions (rather than OH⁻ as it does during operation with the electrolyte)—significantly reduces damage to the functional groups. Therefore, brief hot pressing around the glass temperature of PTFE is sufficient to improve electrode structure and layer adhesion and stability, while minimizing the damage to the ionomer and to electrode performance.

FIGS. 5A and 5B provide high resolution scanning electron microscope (HRSEM) images of fuel cell ORR GDE prepared with PTFE (3 wt %) and hot pressing, before and after operation in fuel cell 120 (after durability test, 450 h at 80° C. under 0.5 A/cm²), respectively, according to some embodiments of the invention, compared with FIGS. 5C and 5D that provide HRSEM images of prior art electrodes prepared without PTFE and without hot pressing according to prior art procedures, before and after operation in fuel cell 120 (after durability test, 310 h at 80° C. under 0.5 A/cm²), respectively.

The inventors note that comparing FIGS. 5A, 5B with FIGS. 5C, 5D, it seems that the PTFE and hot pressing helped keep the uniformity and integrity of the catalyst layer, preventing cracks and voids from being created during the durability test, and practically maintaining the layer morphology throughout the fuel cell operation. It is suggested that the binder creates a fine net that contributes to the stability of the layer, fixes its morphology and in small quantity does not interfere too much with the hydrophilicity/hydrophobicity of the layer, thereby keeping its good ionic conductivity—that is essential for stable durability test. In contrast, in prior art electrodes without binder and hot pressing, the catalyst layer is less uniform and exhibits non-patterned channels, cracks and voids that seem to have been created during the durability test, probably decreasing the voltage are related to leaching of ionomer and catalyst material which, together with reduced conductivity and formation of inactive regions contribute to fuel cell degradation. It is noted that upon applying hot pressing without addition of binder only minor changes in electrode durability have been observed. It is further noted that the exact percentage of binder and parameters of the hot pressing may change and be optimized with respect to the size, constituents and purpose of the electrode.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A method comprising preparing a cell element that is operable in an alkaline or an anion exchange electrochemical device, by:
applying a mixture comprising a catalyst dispersion and a binder dispersion onto the cell element, and
hot pressing the cell element with the applied mixture.

2. The method of claim 1, wherein the cell element is at least one of: a hydrogen-side electrode, an oxygen-side electrode and a membrane of the electrochemical device.

3. The method of claim 1, wherein the hot pressing is carried out at or near a glass transition temperature of the binder, optionally between hot plates.

4. The method of claim 1, wherein the applying of the mixture is carried out by sonicating and spraying the mixture onto the cell element.

5. The method of claim 1, wherein the catalyst dispersion comprises particles of at least one of: Pt, Ag, Ir, Pd, Ru, Ni, Co, Fe, Pd and their alloys, mixtures, oxides or mixed oxides, and the binder dispersion comprises particles of at least one of: polytetrafluoroethylene (PTFE), chlorotrifluoroethylene (CTFE), perfluoroalkoxy alkane (PFA), ethylene tetrafluoroethylene (ETFE), polyvinylidene fluoride (PVDF) and poly (methyl-methacrylate) (PMMA).

6. The method of claim 1, wherein the preparing of the cell element is for being operable in an anion exchange electrochemical device, and further comprising including ionomer in the applied mixture.

7. The method of claim 1, further comprising preparing a membrane electrode assembly (MEA) that is operable in the alkaline or anion exchange electrochemical device and comprises a hydrogen-side electrode and an oxygen-side electrode separated by a membrane, with catalyst layers between each electrode and the membrane, by preparing adjacent cell elements with the coated catalyst layer.

8. The method of claim 7, comprising coating one of the catalyst layers on a GDL of the hydrogen-side electrode and coating another one of the catalyst layers on a PTL of the oxygen-side electrode.

9. The method of claim 7, comprising coating catalyst layers on either side of the membrane to form a CCM.

10. The method of claim 7, comprising coating one of the catalyst layers on a GDL of the hydrogen-side electrode and coating another one of the catalyst layers on a side of the membrane which faces the oxygen-side electrode.

11. The method of claim 10, further comprising protecting the uncoated side of the membrane during the hot pressing by coating with binder and optionally reinforcing the uncoated side.

12. The method of claim 7, comprising coating one of the catalyst layers on a PTL of the oxygen-side electrode and coating another one of the catalyst layers on a side of the membrane which faces the hydrogen-side electrode.

13. The method of claim 12, further comprising protecting the uncoated side of the membrane during the hot pressing by coating with binder and optionally reinforcing the uncoated side.

14. The method of claim 7, further comprising configuring the alkaline or anion exchange electrochemical device as a fuel cell, an electrolyzer or as a reversible dual device.

15. A cell element that is operable in an alkaline or an anion exchange electrochemical device, the cell element coated by at least one catalyst layer that comprises a catalyst mixed with a binder and is hot pressed onto the cell element.

16. The cell element of claim 15, configured as a hydrogen-side electrode, with the catalyst layer coated on a gas diffusion layer (GDL) to form the cell element as a gas diffusion electrode (GDE) of the electrochemical device, wherein the GDL is carbon-based and the GDE is configured as at least one of: a hydrogen evolution reaction (HER) electrode operable in an electrolyzer, a hydrogen evolution/oxidation reaction (HER/HOR) electrode operable in a dual cell, and/or a HOR electrode operable in a fuel cell.

17. The cell element of claim 15, configured as an oxygen-side electrode, with the catalyst layer coated on a porous transfer layer (PTL) to form the cell element as a GDE of the electrochemical device, wherein the PTL is metal-based and the GDE is configured as at least one of: an oxygen evolution reaction (OER) electrode operable in an electrolyzer, an oxygen evolution/reduction reaction (OER/ORR) electrode operable in a dual cell, and/or an ORR electrode operable in a fuel cell.

18. The cell element of claim 15, configured as a catalyst coated membrane (CCM), with two catalyst layers coated on either side of a membrane of the electrochemical device.

19. An alkaline or an anion exchange electrochemical device with cell elements comprising a hydrogen-side electrode and an oxygen-side electrode separated by a membrane, with catalyst layers between each electrode and the membrane, wherein the catalyst layers comprise a catalyst mixed with a binder and wherein each catalyst layer is hot pressed onto an adjacent cell element.

20. The electrochemical device of claim 19, wherein the catalyst comprises at least one of: Pt, Ag, Ir, Pd, Ru, Ni, Co, Fe, Pd and their alloys, mixtures, oxides or mixed oxides, and the binder comprises at least one of: PTFE, CTFE, PFA, ETFE, PVDF, and PMMA.
